(19) United States
(12) Patent Application Publication
(10) Pub. No.: US 2024/0165626 A1
(43) Pub. Date: May 23, 2024

(54) METHODS AND SYSTEMS FOR DISPENSING AND EXTRACTING REAGENTS

(71) Applicant: 10x Genomics, Inc., Pleasanton, CA (US)

(72) Inventors: Eric EVJE, Oakland, CA (US); Xueda SHI, San Jose, CA (US); Yiran ZHANG, Castro Valley, CA (US)

(73) Assignee: 10x Genomics, Inc., Pleasanton, CA (US)

(21) Appl. No.: 18/507,195

(22) Filed: Nov. 13, 2023

Related U.S. Application Data
(60) Provisional application No. 63/426,329, filed on Nov. 17, 2022.

(51) Int. Cl. B01L 3/00; G01N 35/10

(52) U.S. Cl. CPC B01L 3/52; G01N 35/1002; B01L 2200/025; B01L 2200/028; B01L 2200/16; B01L 2300/0809; B01L 2300/161; G01N 2021/6439

(57) ABSTRACT

Various embodiments of the present disclosure disclose methods and systems for dispensing a reagent into a sample well and efficiently extracting the dispensed reagent from the sample well after the reagent is used for detecting molecules in a sample. The amount of probe reagents dispensed may be no more than what is needed to immerse the sample and allow effective probing of the sample by the probes in the reagent.

### CROSS REFERENCE TO RELATED APPLICATION

This application claims priority to U.S. provisional patent application Ser. No. 63/426,329 filed Nov. 17, 2022, the entire content of which is incorporated herein by reference and relied upon.

### FIELDS OF THE DISCLOSURE

The present disclosure is directed to methods, systems, and devices for dispensing and extracting reagents in an opto-fluidic instrument. In particular, the present disclosure describes methods and systems for dispensing one or more reagents into a sample well and extracting the dispensed reagents from the sample well.

### SUMMARY

Various embodiments of the present disclosure disclose a method for dispensing a reagent into a sample well. In various embodiments, the method comprises providing an optofluidic instrument comprising: an optics module, a fluidics module having a dispense nozzle, and a sample interface module. Further, the method comprises positioning the dispense nozzle over a well, the well defined by a floor made from a glass substrate and a wall formed by a gasket surrounding the floor. Further, the method comprises dispensing, using the dispense nozzle, a reagent onto the well. In various embodiments, the dispensing includes moving the dispense nozzle with respect to the well such that (i) the reagent is dispensed at a plurality of dispensation locations along an edge of the well outside a sample section thereof; and (ii) at least a first pair of the plurality of dispensation locations are positioned substantially opposite from each other.

Various embodiments of the present disclosure disclose a method for extracting a reagent from a sample well. In various embodiments, the method comprises providing an optofluidic instrument comprising: an optics module, a fluidics module having a dispense nozzle, and a sample interface module. Further, the method comprises positioning an extraction nozzle over a well, the well defined by a first portion of a substrate (e.g., a floor made from a glass substrate) and a wall formed by a gasket surrounding the first portion (e.g., a gasket surrounding the floor). Further, the method comprises extracting, using the extraction nozzle, a portion of the reagent from one or more extraction locations on the well. In various embodiments, a number of the one or more extraction locations is selected based on a surface characteristic of the well.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is an example workflow of analysis of a biological sample (e.g., a cell or tissue sample) using an opto-fluidic instrument, according to various embodiments.

FIG. 2 illustrates a sample device including a well (e.g., a sample well), which is defined by a substrate and a gasket, according to various embodiments.

FIG. 3 illustrates a substrate of a sample device and reagent dispensation locations on the substrate, according to various embodiments.

FIG. 4 illustrates a contact angle of a reagent on a substrate surface, according to various embodiments.

FIGS. 5A-5D illustrate the dispensation of a reagent into a sample device, according to various embodiments.

FIG. 6 is a flowchart illustrating the dispensation of a reagent into a sample device, according to various embodiments.

FIG. 7 is a flowchart illustrating the extraction of a reagent from a sample device, according to various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

Target molecules (e.g., nucleic acids, proteins, antibodies, etc.) can be detected in biological samples (e.g., one or more cells or a tissue sample) using an instrument having integrated optics and fluidics modules (an “opto-fluidic instrument”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some embodiments, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in-situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from eukaryotic mammalian and eukaryotic non-mammalian organisms (e.g., a plant, a fungus an insect, an arachnid, a nematoda, a reptile, or an amphibian). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some embodiments, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay using the opto-fluidic instruments disclosed herein. Except where indicated otherwise, the preparative or processing steps described below can generally be combined in any manner and in any order to appropriately prepare or process a particular sample for and/or analysis.

For example, a biological sample can be harvested from a subject (e.g., via surgical biopsy, whole subject sectioning) or grown in vitro on a growth substrate or culture dish as a population of cells and prepared for analysis as a tissue slice or tissue section (e.g., a fresh frozen, fixed frozen, or formalin fixed paraffin embedded (FFPE) tissue section). The thickness of a tissue section typically depends on the method used to prepare the section and the physical characteristics of the tissue, and therefore sections having a wide variety of different thicknesses can be prepared and used.

In some embodiments, the biological sample is fixed in any of a variety of suitable fixatives to preserve the biological structure of the sample prior to analysis. Exemplary fixatives include formalin, formaldehyde, ethanol, methanol, acetone, paraformaldehyde (PFA)-Triton, and combinations thereof.

In some embodiments, the biological sample can be permeabilized to facilitate transfer of analytes out of the sample, and/or to facilitate transfer of species (such as probes or probes sets) into the sample. In general, the biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases).

In some embodiments, the biological sample is embedded in a polymer and/or crosslinked matrix (e.g., a hydrogel matrix). Embedding the sample in this manner typically involves contacting the biological sample with a hydrogel such that the biological sample becomes surrounded by the hydrogel. For example, the sample (e.g., a tissue section on a substrate, such as a glass substrate) can be embedded by contacting the sample with a suitable polymer material and activating the polymer material to form a hydrogel. In some embodiments, the hydrogel is formed such that the hydrogel is internalized within the biological sample. In some embodiments, the biological sample (including biological analytes) is immobilized in the hydrogel via cross-linking of the polymer material that forms the hydrogel. Cross-linking can be performed chemically and/or photochemically, or alternatively by any other suitable hydrogel-formation method. In some embodiments, biological molecules (or derivatives thereof) are cross-linked or otherwise covalently attached to the hydrogel. For example, in some embodiments, nucleic acid molecules (or derivatives thereof, such as an amplification product or probe(s) bound to cellular nucleic acid molecule) in a tissue sample are cross-linked or otherwise covalently attached to the hydrogel.

Hydrogels embedded within biological samples can be cleared using any suitable method. For example, electrophoretic tissue clearing methods or surfactant-based (e.g., sodium dodecyl sulfate (SDS)) clearing methods can be used to remove biological macromolecules from the hydrogel-embedded sample.

Tissue clearing is a process of optically resolving a sample or complex biological material, such as whole organs, large tissue, and cellular models, with minimal changes to morphology and without compromising the ability for immunolabeling or fluorescence imaging detection. In various embodiments, refractive index matching is used for obtaining fluorescence images. Mismatching among mediums can cause loss of imaging resolution, as light may also travel through the sample itself, a mounting media, glass coverslip, oil, and/or a microscope objective. In various embodiments, the amount of variable scattering of light from cellular membranes, lipids, and/or molecules of the specimen is reduced (e.g., minimized) using the various methods described herein. Heterogeneity of scattering among the cellular components may lead to an increase in opaqueness of an image. In various embodiments, a denser makeup of lipids, trafficking organelles, and other subcellular molecules may increase lateral, or non-forward, light scattered. In various embodiments, non-forward light scattering in situ may not pass through the specimen, as it is exacerbated by the continuous, pinball like, interactions of scattered light with neighboring molecules. In various embodiments, through the multiplicity of scattering, refraction, and absorbance the energy of light may be reduced or ultimately lost, leading to a distorted and white, non-translucent image. In various embodiments, a clearing reagent and mountant optically clears the sample by matching the refractive index to minimizing the light scattering through the specimen and to the microscope objective.

In various embodiments, optical clearing may be performed via various different approaches, primarily being divided into chemical and matrix-based approaches. In various embodiments, chemical approaches include aqueous-based or solvent-based approaches to achieve a highly resolved 3D image for immunolabeling, immuno-cytochemistry, immuno-histochemistry, and/or immunofluorescence. In various embodiments, aqueous-based clearing approaches are generally used to avoid dehydration and toxicity, which can destroy the integrity of a sample.

In various embodiments, passive clarity technique (PACT) is a passive tissue clearing and immunolabeling protocol. In various embodiments, PACT is used for intact thick organs. In various embodiments, RIMS includes a protocol for passive tissue clearing and immunostaining of intact organs that is compatible for long-term storage and has imaging media that preserves fluorescent markers over months.

In various embodiments, refractive index matching solutions (RIMS) may be produced with sugar or glycerol for simple, passive immersion. This may be used with thinner or smaller samples, as they are easier to clear and can maintain fluorescent protein emission. In various embodiments, such immersion techniques may achieve less than 1.5 refractive index and can take days to achieve clearing, resulting in reduced image quality when compared to solvent approaches, due to refractive index mismatching between the cleared sample, the glass coverslip, and immersion oil (glass and oil have an RI of 1.51). As sugar or glycerol solutions may take extended periods for clearing, a sample can experience considerable shrinkage while losing lipid content. In various embodiments, commercially available solutions control morphological alterations and loss of lipid content while achieving a higher refractive index of 1.52. In various embodiments, considerations for clearing include sample type and thickness so that there is minimal shrinkage of the sample and preservation of lipid content and fluorescence.

In various embodiments, perfusion-assisted agent release in situ (PARS) includes a method for whole-body clearing and phenotyping compatible with endogenous fluorescence. In various embodiments, all steps for PARS, including preservation, clearing, and labeling, are performed in situ prior to tissue extraction. In various embodiments, PARS, together with RIMS, transform opaque, intact, whole-organisms into optically transparent, fluorescently labeled samples for visualization with conventional confocal microscopy and phenotypic analysis at the cellular, subcellular, and/or single-molecule transcripts level as described in “Single-Cell Phenotyping within Transparent Intact Tissue through Whole-Body Clearing” by Yang et al. Cell. Vol 158, Issue 4, P945-958, (Aug. 14, 2014) (accessible online at https://doi.org/10.1016/j.cell.2014.07.017).

A biological sample may comprise one or a plurality of analytes of interest. The opto-fluidic instruments disclosed herein can be used to detect and analyze a wide variety of different analytes. In some aspects, an analyte can include any biological substance, structure, moiety, or component to be analyzed. For example, the analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed and detected (e.g., using the opto-fluidic instruments disclosed herein).

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof. The analyte may be a single molecule or a complex that contains two or more molecular subunits, e.g., including but not limited to complexes between proteins or peptides and nucleic acid molecules such as DNA or RNA, e.g., interactions between proteins and nucleic acids, e.g., regulatory factors, such as transcription factors, and DNA or RNA.

In some embodiments, the opto-fluidic instruments described herein can be utilized for the in situ detection and analysis of cellular analytes, (such as nucleic acid sequences), such as fluorescent in situ hybridization (FISH)-based methods, in situ transcriptomic analysis, or in situ sequencing, for example from intact tissues or samples in which the spatial information has been preserved. In some aspects, the embodiments can be applied in an imaging or detection method for multiplexed nucleic acid analysis. In some aspects, the provided opto-fluidic instruments can be used to detect a signal associated with a detectable label of a nucleic acid probe that is hybridized to a target sequence of a target nucleic acid in a biological sample.

Disclosed herein, in some aspects, are labelling agents (e.g., nucleic acid probes and/or probe sets) that are introduced into a cell or used to otherwise detect an analyte in a biological sample such as a tissue sample. The labelling agents include nucleic acid-based probes (e.g., the primary probes disclosed herein and/or any detectable probe disclosed herein) and may comprise any of a variety of entities that can hybridize to a nucleic acid, typically by Watson-Crick base pairing, such as DNA, RNA, LNA, PNA, etc. The nucleic acid probes may comprise a hybridization region that is able to directly or indirectly bind to at least a portion of a target sequence in a target nucleic acid. The nucleic acid probe may be able to bind to a specific target nucleic acid (e.g., an mRNA, or other nucleic acids disclosed herein).

Specific probe designs can vary depending on the application and any suitable probe or probe set may be utilized and detected using the opto-fluidic instruments described herein. In some aspects, the probes or probe sets described herein, or intermediate probes (e.g., a secondary probe, and/or a higher order probe) can be selected from the group consisting of a circular probe, a circularizable probe, and a linear probe. In some embodiments, a circular probe is pre-circularized prior to hybridization to a target nucleic acid and/or one or more other probes. In some embodiments, a circularizable probe is circularized (e.g., by ligation) upon hybridization to a target nucleic acid and/or one or more other probes such as a splint. In some embodiments, a linear probe can be one that comprises a target recognition sequence and a sequence that does not hybridize to a target nucleic acid, such as a 5′ overhang, a 3′ overhang, and/or a linker or spacer (which may comprise a nucleic acid sequence, such a one or more barcode sequence, or a non-nucleic acid moiety). In some embodiments, the sequence (e.g., the 5′ overhang, 3′ overhang, and/or linker or spacer) is non-hybridizing to the target nucleic acid but may hybridize to one another and/or one or more other probes, such as detectably labeled probes.

In some embodiments, a primary probe, a secondary probe, and/or a higher order probe disclosed herein can comprise a padlock-like probe or probe set, such as one described in U.S. Pat. No. 8,551,710, US 2020/0224244, US 2019/0055594, US 2021/0164039, US 2016/0108458, or US 2020/0224243, each of which is incorporated herein by reference in its entirety. Any suitable combination of the probe designs described herein can be used.

In some embodiments, the probes or probe sets described herein (e.g., a primary probe, or a secondary probe, and/or a higher order probe disclosed herein) can comprise two or more parts. In some cases, a probe can comprise one or more features of and/or be modified based on: a split FISH probe or probe set described in WO 2021/167526A1 or Goh et al., “Highly specific multiplexed RNA imaging in tissues with split-FISH,” Nat Methods 17(7):689-693 (2020), which are incorporated herein by reference in their entireties; a Z-probe or probe set, such as one described in U.S. Pat. Nos. 7,709,198 B2, 8,604,182 B2, 8,951,726 B2, 8,658,361 B2, or Tripathi et al., “Z Probe, An Efficient Tool for Characterizing Long Non-Coding RNA in FFPE Tissues,” Noncoding RNA 4(3):20 (2018), which are incorporated herein by reference in their entireties; an HCR initiator or amplifier, such as one described in U.S. Pat. No. 7,632,641 B2, US 2017/0009278 A1, U.S. Pat. No. 10,450,599 B2, or Choi et al., “Third-generation in situ hybridization chain reaction: multiplexed, quantitative, sensitive, versatile, robust,” Development 145(12): dev165753 (2018), which are incorporated herein by reference in their entireties; a PLAYR probe or probe set, such as one described in US 2016/0108458 A1 or Frei et al., “Highly multiplexed simultaneous detection of RNAs and proteins in single cells,” Nat Methods 13(3):269-75 (2016), which are incorporated herein by reference in their entireties; a PLISH probe or probe set, such as one described in US 2020/0224243 A1 or Nagendran et al., “Automated cell-type classification in intact tissues by single-cell molecular profiling,” eLife 7:e30510 (2018), which are incorporated herein by reference in their entireties; a RollFISH probe or probe set such as one described in Wu et al., “RollFISH achieves robust quantification of single-molecule RNA biomarkers in paraffin-embedded tumor tissue samples,” Commun Biol 1, 209 (2018), which is hereby incorporated by reference in its entirety; a MERFISH probe or probe set, such as one described in US 2022/0064697 A1 or Chen et al., “Spatially resolved, highly multiplexed RNA profiling in single cells,” Science 348(6233):aaa6090 (2015), which are incorporated herein by reference in their entireties; a primer exchange reaction (PER) probe or probe set, such as one described in US 2019/0106733 A1, which is hereby incorporated by reference in its entirety.

In some embodiments, probes and/or probe sets are directly labeled with one or more detectable labels (e.g., an optically detectable label, such as a florescent moiety) that are detected on the opto-fluidic instruments disclosed herein. In other embodiments, probes and/or probe sets comprise a target binding region and one or more nucleic acid barcode sequences that identify the analyte. In these embodiments, the barcode sequence(s) may be detected on the opto-fluidic instruments disclosed herein to identify the analyte in the sample. In some embodiments, a probe or probe set disclosed herein is a circularizable probe or probe set (e.g., a padlock probe or padlock-like probe) comprising a barcode region comprising one or more barcode sequences.

The probes and/or probe sets describe herein may comprise any suitable number of barcode sequences. In some embodiments, the probes or probe sets may comprise 1, 2, 3, 4, 5, 6, 7, 8, 9, 10, 11, 12, 13, 14, 15 or more, 20 or more, 30 or more, 40 or more, or 50 or more barcode sequences. As an illustrative example, a first probe may contain a first target-binding sequence, a first barcode sequence, and a second barcode sequence, while a second, different probe may contain a second target-binding sequence (that is different from the first target-binding sequence in the first probe), the same first barcode sequence as in the first probe, but a third barcode sequence instead of the second barcode sequence. Such probes may thereby be distinguished by determining the various barcode sequence combinations present or associated with a given probe at a given location in a sample.

In some embodiments, a labelling agent may include analyte binding moiety that interacts with an analyte (e.g., a protein) in the sample (e.g., a cell or tissue sample) and a reporter oligonucleotide comprising one or more barcode sequences associated with the analyte and/or analyte binding moiety. For example, a labelling agent that is specific to one type of cell feature (e.g., a first protein) may have coupled thereto a first reporter oligonucleotide, while a labelling agent that is specific to a different cell feature (e.g., a second protein) may have a different reporter oligonucleotide coupled thereto. In some embodiments, an analyte binding moiety includes, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. For a description of exemplary labelling agents, reporter oligonucleotides, and methods of use, see, e.g., U.S. Pat. 10,550,429; U.S. Pat. Pub. 20190177800; and U.S. Pat. Pub. 20190367969, which are each incorporated by reference herein in their entirety.

In some embodiments, the nucleic acid probes, probe sets, reporter oligonucleotides, barcode sequences, etc. may be detected directly on the opto-fluidic instruments disclosed herein (e.g., primary probes comprise a detectable label, such as a florescent moiety), and/or by using secondary (or higher order) nucleic acid probes able to bind to the primary probes. In some embodiments, the nucleic acid probes (e.g., primary probes and/or secondary probes) are compatible with one or more biological and/or chemical reactions. For instance, a nucleic acid probe disclosed herein can serve as a template or primer for a polymerase (e.g., a circularized probe in a rolling circle amplification (RCA) reaction), a template or substrate for a ligase, a substrate for a click chemistry reaction, and/or a substrate for a nuclease (e.g., endonuclease or exonuclease for cleavage or digestion). In some embodiments, labelling agents (such as a primary probe set) are added to a biological sample (e.g., a cell or tissue sample) using the opto-fluidic instrument and subsequently detected using opto-fluidic instrument (e.g., using detectably labeled primary probes, sequential hybridization of detectable labelled oligonucleotides to primary probes, in situ sequencing (e.g., SBS, SBL, SBH), and the like). In some embodiments, labelling agents (such as a primary probe set) are added to a biological sample (e.g., a cell or tissue sample) outside the optofluidic instrument and the sample is loaded onto the opto-fluidic instruments disclosed herein for detection (e.g., using sequential hybridization of detectable labelled oligonucleotides, in situ sequencing (e.g., SBS, SBL, SBH), and the like).

In some embodiments, detection of the analytes, probes, probe sets, barcodes, etc. described herein can be performed in situ on the opto-fluidic instruments disclosed herein. In situ sequencing typically involves incorporation of a labeled nucleotide (e.g., fluorescently labeled mononucleotides or dinucleotides) in a sequential, template-dependent manner or hybridization of a labeled primer (e.g., a labeled random hexamer) to a nucleic acid template such that the identities (e.g., nucleotide sequence) of the incorporated nucleotides or labeled primer extension products can be determined, and consequently, the nucleotide sequence of the corresponding template nucleic acid. Aspects of in situ sequencing approaches are described, for example, in Mitra et al., “Fluorescent in situ sequencing on polymerase colonies” Anal. Biochem. 320, 55-65 (2003), and Lee et al., “Highly Multiplexed Subcellular RNA Sequencing in Situ” Science, 343(6177) (2014), 1360-1363. In addition, examples of methods and systems for performing in situ sequencing are described in US 2016/0024555, US 2019/0194709, and in U.S. Pat. Nos. 10,138,509, 10,494,662 and 10,179,932.

In some embodiments, sequencing can be performed by sequencing-by-synthesis (SBS). In some embodiments, a sequencing primer is complementary to sequences at or near the target to be detected (e.g., one or more barcode(s)). In such embodiments, sequencing-by-synthesis can comprise reverse transcription and/or amplification in order to generate a template sequence from which a primer sequence can bind. Exemplary SBS methods comprise those described for example, but not limited to, US 2007/0166705, US 2006/0188901, U.S. Pat. No. 7,057,026, US 2006/0240439, US 2006/0281109, US 2011/0059865, US 2005/0100900, U.S. Pat. No. 9,217,178, US 2009/0118128, US 2012/0270305, US 2013/0260372, and US 2013/0079232.

In some embodiments, sequence analysis of nucleic acids (e.g., nucleic acids such as RCA products comprising barcode sequences) can be performed by sequential hybridization (e.g., sequencing by hybridization and/or sequential in situ fluorescence hybridization). Sequential fluorescence hybridization can involve sequential hybridization of detection probes comprising an oligonucleotide and a detectable label. In some embodiments, a method disclosed herein comprises sequential hybridization of the detectable probes disclosed herein, including detectably labeled probes (e.g., fluorophore conjugated oligonucleotides) and/or probes that are not detectably labeled per se but are capable of binding (e.g., via nucleic acid hybridization) and being detected by detectably labeled probes. Exemplary methods comprising sequential fluorescence hybridization of detectable probes are described in US 2019/0161796, US 2020/0224244, US 2022/0010358, US 2021/0340618, and WO 2021/138676, MERFISH (described for example in Moffitt et. al., “Chapter One—RNA Imaging with Multiplexed Error-Robust Fluorescence In Situ Hybridization (MERFISH)” Methods in Enzymology, 572, 1-49 (2016)), and hybridization-based in situ sequencing (HybISS) (described for example in Gyllborg et al., “Hybridization-based in situ sequencing (HybISS) for spatially resolved transcriptomics in human and mouse brain tissue,” Nucleic Acids Res 48(19):e112 (2020)) all of which are incorporated herein by reference.

In some embodiments, sequencing can be performed using sequencing by ligation (SBL). Such techniques utilize DNA ligase to incorporate oligonucleotides and identify the incorporation of such oligonucleotides. The oligonucleotides typically have different labels that are correlated with the identity of a particular nucleotide in a sequence to which the oligonucleotides hybridize. Aspects and features involved in sequencing by ligation are described, for example, in Shendure et al., “Accurate Multiplex Polony Sequencing of an Evolved Bacterial Genome,” Science, 309: 1728-1732 (2005), and in U.S. Pat. Nos. 5,599,675; 5,750,341; 6,969,488; 6,172,218; and 6,306,597. Exemplary techniques for in situ SBL comprise, but are not limited to, STARmap (described for example in Wang et al., “Three-dimensional intact-tissue sequencing of single-cell transcriptional states,” Science, 361(6499) 5691 (2018)) and US 2021/0164039).

In some embodiments, probe barcodes (e.g., plurality of probes or probe sets comprising one or more barcode sequences) or complements or products thereof are targeted by detectably labeled detection oligonucleotides, such as fluorescently labeled oligonucleotides. In some embodiments, one or more decoding schemes (e.g., sequential rounds of fluorescent probe hybridization) are used on the opto-fluidic instruments disclosed herein to decode the signals, such as fluorescence, for sequence identification. In any of the embodiments herein, barcodes (e.g., primary and/or secondary barcode sequences) can be analyzed (e.g., detected or sequenced using the opto-fluidic instruments disclosed herein) using any suitable methods or techniques, comprising those described herein, such as RNA sequential probing of targets (RNA SPOTs), sequential fluorescent in situ hybridization (seqFISH), single-molecule fluorescent in situ hybridization (smFISH), multiplexed error-robust fluorescence in situ hybridization (MERFISH), hybridization-based in situ sequencing (HybISS), in situ sequencing, targeted in situ sequencing, fluorescent in situ sequencing (FISSEQ), or spatially-resolved transcript amplicon readout mapping (STARmap). In some embodiments, the methods provided herein comprise analyzing the barcodes by sequential hybridization and detection with a plurality of labelled probes (e.g., detection oligonucleotides or detectable probes). Exemplary decoding schemes are described in Eng et al., “Transcriptome-scale Super-Resolved Imaging in Tissues by RNA SeqFISH+,” Nature 568(7751):235-239 (2019); Chen et al., Science; 348(6233): aaa6090 (2015); Gyllborg et al., Nucleic Acids Res (2020) 48(19):e112; U.S. Pat. No. 10,457,980 B2; US 2016/0369329 A1; WO 2018/026873 A1; and US 2017/0220733 A1, all of which are incorporated by reference in their entirety. In some embodiments, these assays enable signal amplification, combinatorial decoding, and error correction schemes at the same time.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids used for establishing the experimental conditions used for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The opto-fluidic instrument may also include other ancillary modules configured to facilitate the operation of the opto-fluidic instrument, such as, but not limited to, cooling systems, motion calibration systems, etc.

As noted above, reagents such as washing reagents, stripping reagents, imaging buffers, etc. (collectively referred hereinafter as “reagents”), may be delivered to a sample device to prepare a sample placed therein for detecting target molecules in the sample. Further, probe reagents including probes (e.g., fluorescently tagged and/or untagged oligonucleotides) may also be delivered to the sample device for use in detecting the target molecules in the sample. In various embodiments, the delivery of the reagents to the sample device may be controlled, for instance, to reduce cost, improve probing processes, avoid contamination, etc. For example, to reduce (e.g., minimize) an amount of probe reagent used (thereby reducing wasted reagents, which can be costly), the probe reagent(s) are delivered into the sample device in a manner that delivers the minimum yet adequate amount of the probe reagent to fully immerse the sample. For instance, the amount of probe reagent that is dispensed into the sample device may be amount allowing for an effective sample immersion volume (ESIV) of the reagent. That is, the amount of the probe reagent used may immerse the sample and allow effective probing of the sample by the probes in the reagent (e.g., to detect the target molecules). As another example, to reduce contamination, reagents may be removed from the sample device as efficiently as possible in between probing cycles. Accordingly, there exists a need for methods and systems for controlling the dispensation of a reagent into a sample well and efficiently extracting the dispensed reagent from the sample well.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### II. Example Descriptions of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination

As used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to #15%, +10%, +5%, or +1% as understood by a person of skill in the art.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

### III. Opto-Fluidic Instruments for Analysis of Samples

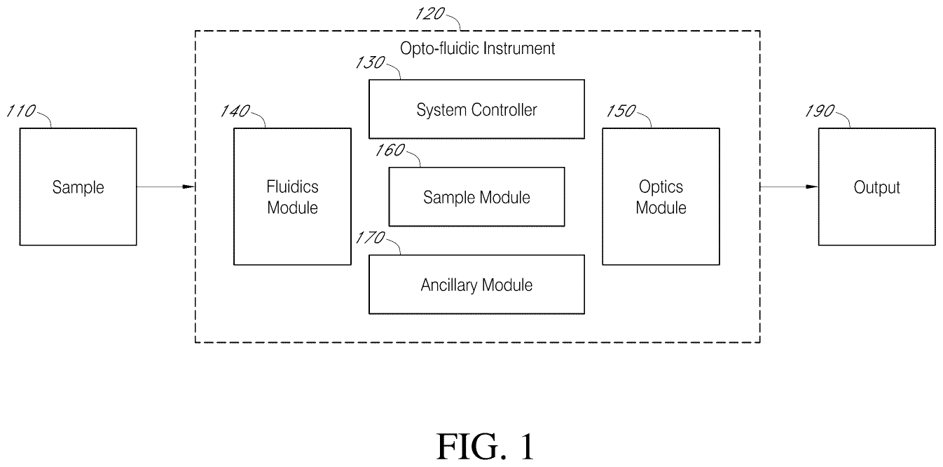

FIG. 1 shows an example workflow of analysis of a sample 110 (e.g., cell or tissue sample) using an opto-fluidic instrument 120, according to various embodiments. In various embodiments, the sample 110 can be a biological sample (e.g., a tissue) that includes molecules targeted for analysis (i.e., target molecules), such as DNA, RNA, proteins, antibodies, etc. In various embodiments, the biological sample is a fresh frozen tissue. In various embodiments, the biological sample is a formalin-fixed paraffin-embedded (FFPE) sample. For example, the sample 110 can be a sectioned tissue that is treated to access the RNA thereof for labeling with circularizable DNA probes. In various embodiments, ligation of the probes generates a circular DNA probe which can be enzymatically amplified and bound with fluorescent oligonucleotides to produce a sufficiently bright signal that facilitates image acquisition and has a high signal-to-noise ratio.

In various embodiments, the sample 110 may be placed in the opto-fluidic instrument 120 for analysis and detection of the target molecules in the sample 110. In various embodiments, the opto-fluidic instrument 120 is configured to facilitate the experimental conditions conducive for the detection of the target molecules. For example, the opto-fluidic instrument 120 can include a fluidics module 140, an optics module 150, a sample module 160, and at least one ancillary module 170, and these modules may be operated by a system controller 130 to create the experimental conditions for the probing of the target molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components. In various embodiments, the various modules of the opto-fluid instrument may be in electrical communication with each other. In various embodiments, at least some of the modules of the opto-fluidic instrument 120 may be integrated together into a single module.

In various embodiments, the sample module 160 may be configured to receive the sample 110 in the opto-fluidic instrument 120. For instance, the sample module 160 may include a sample interface module (SIM) that is configured to receive a sample device (e.g., cassette) in which a substrate (having the sample 110 positioned thereon) can be secured. In various embodiments, the substrate is a glass slide. That is, the sample 110 may be placed in the opto-fluidic instrument 120 by securing the substrate having the sample 110 (e.g., the sectioned tissue) within the sample device that is then inserted into the SIM of the sample module 160. In various embodiments, the SIM includes an alignment mechanism configured to secure the sample device within the SIM and align the sample device in X, Y, and Z axes within the SIM. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along a two-dimensional (2D) plane of the opto-fluidic instrument 120. Additional discussion related to the SIM can be found in U.S. application Ser. No. 18/328,200, filed Jun. 2, 2023, titled “Methods, Systems, and Devices for Sample Interface,” which is incorporated herein by reference in its entirety.

The experimental conditions that are conducive for the detection of the target molecules in the sample 110 may depend on the target molecule detection technique that is employed by the opto-fluidic instrument 120. For example, in various embodiments, the opto-fluidic instrument 120 can be a system that is configured to detect molecules in the sample 110 via hybridization of probes. In such cases, the experimental conditions can include molecule hybridization conditions that result in the intensity of hybridization of the target molecule (e.g., nucleic acid) to a probe (e.g., oligonucleotide) being significantly higher when the probe sequence is complementary to the target molecule than when there is a single-base mismatch. The hybridization conditions include the preparation of the sample 110 using reagents such as washing/stripping reagents, probe reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include one or more reservoirs configured to store the reagents, as well as a waste container configured for collecting the reagents (e.g., and other waste) after use by the opto-fluidic instrument 120 to analyze and detect the molecules of the sample 110. In various embodiments, the one or more reservoirs include one or more high use reagent reservoirs. In various embodiments, the fluidics module 140 may be configured to receive one or more low use reagent plates (e.g., a 96 deep well plate). Further, the fluidics module 140 may also include pumps, tubes, pipettes, etc., that are configured to facilitate the transport of the one or more reagents (such non-limiting examples may include high use reagent and/or low use reagent) to the sample device and thus contact the sample 110 with the reagent (such non-limiting examples may include high use reagent and/or low use reagent). For instance, the fluidics module 140 may include one or more pumps (“reagent pumps”) that are configured to pump washing and/or stripping reagents (i.e., high use reagents) to the sample device for use in washing and/or stripping the sample 110. In various embodiments, the fluidics module 140 may be configured for other washing functions such as washing an objective lens of the imaging system of the optics module 150). In some embodiments, a stage (e.g., a Y-Z stage) may be configured to move the pipettes, tubes, etc., along one or more directions, to and from the sample device containing the sample 110, so that the various reagents may be dispensed in the sample device, and spent reagents may be extracted from the sample device.

In various embodiments, the ancillary module 170 includes a cooling system (i.e., a heat transfer system) of the opto-fluidic instrument 120. In various embodiments, the cooling system includes a network of coolant-carrying tubes configured to transport coolant to various modules of the opto-fluidic instrument 120 for regulating the temperatures thereof. In such cases, the ancillary module 170 may include one or more heat transfer components of a heat transfer circuit. In various embodiments, the heat transfer components include one or more coolant reservoirs for storing coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the heat transfer components of the ancillary module 170 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the ancillary module 170 may also include one or more cooling fans that are configured to force air (e.g., cool and/or ambient air) to the external surfaces of the returning coolant reservoirs to thereby cool the heated coolant(s) stored therein. In some instance, the ancillary module 170 may also include one or more cooling fans that are configured to force air directly to one or more components of the opto-fluidic instrument 120 so as to cool said one or more components. For one non-limiting example, the ancillary module 170 may include cooling fans that are configured to directly cool by forcing ambient air past the system controller 130 to thereby cool the system controller 130.

As discussed above, the opto-fluidic instrument 120 may include an optics module 150 which include the various optical components of the opto-fluidic instrument 120, such as but not limited to a camera, an illumination module (such non-limiting examples may include one or more LEDs and/or one or more lasers), an objective lens, and/or the like. The optics module 150 may include a fluorescence imaging system that is configured to image the fluorescence emitted by the probes (e.g., oligonucleotides) in the sample 110 after the probes are excited by light from the illumination module of the optics module 150.

In various embodiments, the system controller 130 may be configured to control the operations of the opto-fluidic instrument 120 (e.g., and the operations of one or more modules thereof). In some embodiments, the system controller 130 may take various forms, including a processor, a single computer (or computer system), or multiple computers in communication with each other. In various embodiments, the system controller 130 may be communicatively coupled with a data storage, a set of input devices, display system, or a combination thereof. In various embodiments, some or all of these components may be considered to be part of or otherwise integrated with the system controller 130, may be separate components in communication with each other, or may be integrated together. In other embodiments, the system controller 130 can be, or may be in communication with, a cloud computing platform.

In various embodiments, the opto-fluidic instrument 120 may analyze the sample 110 and generate the output 190 that includes indications of the presence of the target molecules in the sample 110. For instance, with respect to the example embodiment discussed above where the opto-fluidic instrument 120 employs a hybridization technique for detecting molecules, the opto-fluidic instrument 120 may perform a plurality of probing rounds on the sample 110. During the plurality of probing rounds, the sample 110 undergoes successive rounds of fluorescent probe hybridization (using two or more sets of fluorescent probes, where each set of fluorescent probes is excited by a different color channel) and is volumetrically imaged in a plurality of z-stacks to detect target molecules in the probed sample 110 in three dimensions. In such cases, the output 190 may include a plurality of light signals at specific three-dimensional locations over the plurality of probing cycles. In various embodiments, an optical signature (e.g., a codeword) specific to each gene is determined from the detected optical signals at each three-dimensional location across the plurality of probing cycles, which allows the identification of the target molecules.

### IV. Reagent Dispensation and Extraction in an Opto-Fluidic Instrument

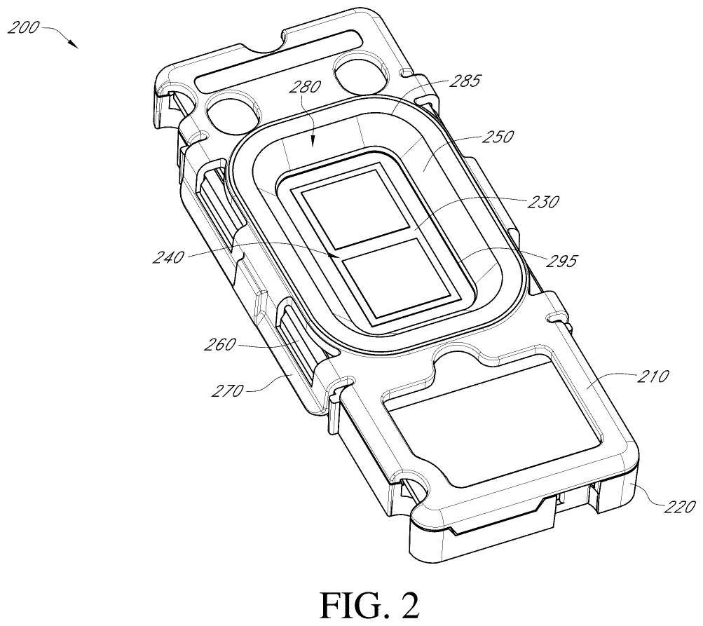

FIG. 2 illustrates a sample device 200 for receiving a sample that is to be probed to detect target molecules (e.g., DNA, RNA, protein, etc.) therein. The sample device 200 is configured to be inserted or otherwise positioned in a SIM of a sample module (e.g., such as the sample module 160 of the opto-fluidic instrument 120 of FIG. 1). In some embodiments, the sample device 200 may be a cassette. In various embodiments, the sample device 200 is an open flow cell. In various embodiments, the sample device 200 may include a top portion 210 and a bottom portion 220 that are configured to engage with each other while a substrate 230 (e.g., a glass slide) is located therebetween such that a well 240 (e.g., a sample well) forms. In some embodiments, the top portion 210 may have one or more snap joints 270 (e.g., cantilevered snap joint) and the bottom portion 220 may have one or more lugs 260 (e.g., cantilevered lugs). In some embodiments, the top portion 210 may have one or more lugs and the bottom portion 220 may have one or more snap joints 270. In various embodiments, the one or more snap joints 270 and the one or more lugs 260 may engage with, or couple to, each other with the substrate sandwiched in between to lock the top portion 210 and the bottom portion 220 together, thereby forming the well 240 that has the substrate 230 (e.g., in particular, the exposed area of the substrate 230) as a floor.

In various embodiments, the sample device 200 may also include a gasket 250 that may serve as a wall for the well 240. In some embodiments, the gasket 250 is configured to form a seal between the substrate 230 and the top portion 210. In some embodiments, the gasket 250 has a wall 280 disposed at an angle from a horizontal surface defined by the bottom (e.g., the substrate 230) of the well 240. That is, an inner wall 280 of the gasket 250 has an angled inner surface between a perimeter 295 of a first opening and a perimeter of 285 a second opening of the gasket 250, where a cross-sectional area of the first opening is smaller than a cross-sectional area of the second opening. When positioned in the sample device 200, the gasket 250 contacts the substrate 230 thereby forming the seal (e.g., along the perimeter 295 of the first opening), which is the boundary of the exposed area of the substrate 230. Further, the angled inner surface of the gasket 250 makes a receding wall 280 (e.g., which corresponds to an inner wall of the well 240) that terminates at the perimeter 285 of the larger second opening of the gasket 250.

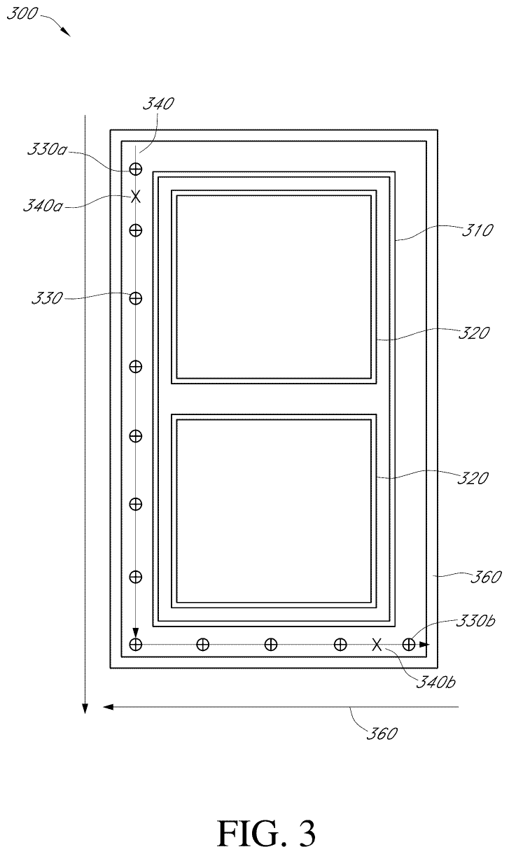

In various embodiments, the substrate 230 includes fiducial markers configured to guide the placement of the sample thereon. In various embodiments, the fiducial markers are configured to provide a reference for tissue image registration across Z-stack images. FIG. 3 illustrates the exposed area 300 of the substrate 230 of FIG. 2 surrounded by the well boundary 360. In some embodiments, the exposed area 300 of the substrate (alternatively referred hereinafter simply as the substrate 300) may include a sample section boundary 320 that indicates the area of the substrate where samples are to be positioned for imaging. These sample section boundary 320 may be positioned within an imageable section boundary 310, which encloses the area of the substrate 300 that an imaging system (e.g., such as an imaging system of the optics module 150 of the opto-fluidic instrument 120 of FIG. 1) can access and image when the sample device is inserted into the sample module 160 of the opto-fluidic instrument 120 of FIG. 1. The substrate 300 may have linear dimensions (e.g., length, width) in the range from about 1 cm to about 3 cm, from about 1.5 cm to about 2.5 cm, including values and subranges therebetween. For instance, the sample section boundary 320 may have a linear dimension of about 1 cm.

In some cases, the surface characteristic of the substrate 230 may be configured to facilitate the attachment of a sample to the substrate. An example of such surface characteristics can be the hydrophilicity of the surface of the substrate 230. The hydrophilicity of a surface to a fluid can be measured in terms of the contact angle the fluid makes with the surface, which is a quantitative measure of the wettability of the surface by the fluid.

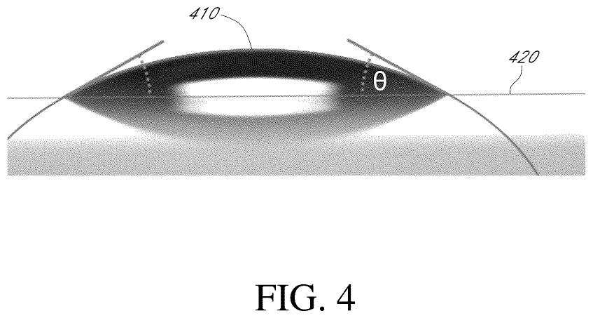

FIG. 4 shows a non-limiting example schematic of a contact angle θ between a fluid 410 and the surface 420 of a substrate. In various embodiments, a surface is hydrophilic to an aqueous fluid (e.g., and as such considered to have high wettability) if a contact angle θ is less than or equal to about 90°. In various embodiments, the surface is hydrophobic to an aqueous fluid (e.g., and as such considered to have low wettability) if the contact angle θ is greater than about 90°.

Back to FIG. 2, in some embodiments, the substrate 230 is configured with a hydrophilic surface, i.e., have high wettability. In some embodiments, the substrate includes a coating (e.g., a hydrophilic coating and/or a hydrophobic coating). In some embodiments, the material of the substrate itself has hydrophilic and/or hydrophobic properties. In some embodiments, a surface of the substrate is modified (e.g., by functionalization, oxidation via a plasma treatment, etc.) to have desired wettability. In some embodiments, the surface is configured to facilitate sample or tissue adhesion to the surface of the substrate 230. In some embodiments, the hydrophilicity of the surface may be such that the surface does not cause sample or tissue sectioning issues such as sample repelling, sample slipping, etc. In some embodiments, for the reagents discussed herein, the contact angle of the surface of the substrate 230 may be in the range from about 20° to about 75°, from about 25° to about 70°, from about 30° to about 60°, including values and subranges therebetween. In various embodiments, the reagents can be washing buffers, stripping buffers, probe reagents, etc. Examples of a washing buffer include but are not limited to deionized water, phosphate-buffered saline (PBS), PBS with dimethyl sulfoxide (DMSO), and/or the like. In some embodiments, the stripping buffer is DMSO, a surfactant, and/or the like. In some embodiments, the surfactant includes polysorbate 20. In some embodiments, the stripping buffer includes the surfactant in a weight proportion of from about 0.01% to about 5%, from about 0.05% to about 2%, from about 0.1% to about 1%, about 0.1%, less than about 1%, including values and subranges therebetween. The probe reagent can be fluorescent probes, such as but not limited to oligonucleotide probes.

In various embodiments, the surface of the substrate 230 has a hydrophilicity that is configured to reduce reagent waste, (e.g., thereby reducing the cost associated therewith when the reagents are particularly expensive, as in the case of probe reagents). In various embodiments, a substantially hydrophilic surface (e.g., where drops of an aqueous fluid have a contact angle with the surface of less than or equal to 90°) reduces reagent waste by providing improved wetting of a liquid on the surface of the substrate. A theoretical mathematical expression for the volume of a small body of fluid (e.g., drops of reagent on the surface of the substrate 230) is

$$V = 2 A \sqrt{\frac{γ}{ρ g}} sin \frac{θ}{2} ,$$

where V is the volume of the fluid, A is the surface area substrate 230) is that is covered by the fluid, γ is the surface tension of the puddle, ρ is the density of the fluid, g is gravitational acceleration, and θ is the contact angle of the fluid with the surface. As such, to reduce the amount of probe reagent that may have to be dispensed into the well 240 to fully immerse the sample disposed on the substrate 230, the substrate 230 may be selected so that the contact angle is low, i.e., the substrate 230 may be selected to have a hydrophilic surface. In various embodiments, the ESIV of the probe reagent may be lowered by using the substrate 230 with a hydrophilic surface onto which reagents are to be dispensed.

In various embodiments, the hydrophilicity of the surface of the substrate 230 improves extraction of a reagent from the well 240 after the reagent is used. This can be advantageous as contaminations and other process inefficiencies can be avoided by fully removing reagents from the sample well once the chemical processes involving the reagents are complete. In various embodiments, hydrophilic substrates, i.e., substrates that form low contact angles with reagents, allow higher reagent extraction efficiencies compared to less hydrophilic substrates, when other factors such as the height of the sipper tube extracting the reagent, the flow rate of the pump that is drawing the reagent from the well 240, etc., are held constant. In some embodiments, reagent extraction efficiency (EF) is defined as follows: EF(%)=(DispW−ExtrW)/(DispW−DryW), where DispW is the weight of the sample device 200 after the reagent is dispensed into the well 240, ExtrW is the weight of the sample device 200 after the reagent is extracted from the well 240, and DryW is the weight of the sample device 200 (e.g., prior to the dispensation of the reagent, i.e., while “dry”).

In some embodiments, the substrate 230 is a glass substrate or a glass slide (e.g., a microscopy slide, cover slip, or other glass substrate). In various embodiments, the substrate 230 may be configured to be hydrophilic. In various embodiments, the substrate 230 is coated with a hydrophilic coating such as but not limited to a hydrogel coating. In various embodiments, the coating is a polymer material that may be activated to form a hydrogel on the surface of the substrate 230. Examples of such hydrophilic coating materials include, but are not limited to, lectins, poly-lysine, antibodies, polysaccharides, and/or the like.

FIG. 3 illustrates the substrate 300 of a sample device and reagent dispensation locations on the substrate. In various embodiments, a sample is positioned on the substrate 300, for example, within an area of the substrate 300 bounded by the sample section boundary 320. In various embodiments, the sample is affixed to the substrate 300. In some embodiments, to dispense a reagent onto the substrate 300, a dispense nozzle that is fluidically connected to a source of the reagent may be positioned over the substrate (e.g., that is, over the well 240 of FIG. 2). In various embodiments, the dispense nozzle can be the nozzle of a pipette that contains the reagent. In various embodiments, the dispense nozzle can be the nozzle of a tube that is fluidically connected to a pumping mechanism (e.g., peristaltic pump, syringe pump, etc.) that transfers reagents stored in a reagent reservoir to the dispense nozzle. In various embodiments, the opto-fluidic instrument 120 of FIG. 1 may include a reagent deck that is configured to store probe reagents for probing the sample to detect molecules therein. In such cases, a pipette or a tube may be used to dispense a probe reagent from the reagent deck onto the substrate 300 of the well 240 of FIG. 2. In another example, the opto-fluidic instrument 120 of FIG. 1 may also include a reagent reservoir that is configured to store reagents for probing, washing, and/or stripping the sample during the process for detecting the molecules. In such cases, pipettes or tubes that are fluidically connected to the reagent reservoir may be positioned above the sample well and be used to dispense the respective reagents onto the substrate 300. For example, the afore-mentioned reagent pump may pump the reagents from the reservoir to the pipettes or the tubes for the dispense nozzle to dispense the reagents onto the substrate 300 of the sample device. The term “fluidically connected”, or variants thereof, may be understood to refer to the connection of a dispense nozzle to the reagent reservoir by fluid paths or tubes that allow reagents to flow therein.

In various embodiments, the dispensation of a reagent from the dispense nozzle onto the substrate 300 of a sample device is intermittent. For example, the reagent may be dispensed at multiple discrete dispensation locations 330. In various embodiments, the dispensation of a reagent from the pipette onto the substrate 300 is performed continuously (e.g., until a predetermined volume of reagent is dispensed from the pipette). In various embodiments, the dispensation may be continuous. For example, the reagent may be dispensed along a continuous dispensation line 340. In some embodiments, these discrete dispensation locations 330 and/or the continuous dispensation line 340 may not be positioned over the sample. For example, the discrete dispensation locations 330 and/or the continuous dispensation line 340 may be outside the sample section boundary 320, or outside the imageable section boundary 310.

In some embodiments, at least two of the multiple discrete dispensation locations 330 may be positioned substantially opposite from each other. For example, two of the multiple discrete dispensation locations 330 (e.g., the initial and last discrete dispensation locations 330a, 330b) may be positioned from each other across the area bounded by the sample section boundary 320, or the imageable section boundary 310. For example, the substrate 300 may have a generally rectangular shape, and in such cases, the discrete dispensation locations 330 include the four corners of the substrate 300.

As another example, at least two points along the continuous dispensation line 340 may be positioned substantially opposite from each other. For instance, two of the points 340a, 340b along the continuous dispensation line 340 may be positioned from each other across the area bounded by the sample section boundary 320, or the imageable section boundary 310. In some embodiments, the discrete dispensation locations 330 and/or the continuous dispensation line 340 may run along most or all of the inside of the perimeter or the well boundary 360 of the substrate 300.

In various embodiments, when dispensing the reagent at the discrete dispensation locations 330 and/or along the continuous dispensation line 340, the dispense nozzle may be in relative motion with respect to the sample device/substrate 300. As discussed above, the sample device may be inserted into a SIM that is mounted on an X-Y stage that is configured to move the SIM (e.g., and as such the sample device and the substrate 300) in the 2D plane (e.g., XY-plane) of the opto-fluidic instrument 120 of FIG. 1. Further, the dispense nozzle may be movable by a stage (e.g., Y-Z stage or X-Y-Z stage) that may be configured to move the pipette in the vertical direction (e.g., Z-direction) as well as one of the directions (e.g., Y-direction) in the 2D plane. In some embodiments, Z-motion of the dispense nozzle (e.g., pipette) is provided by a mechanism (e.g., a linear stage) that it a part of a dispensing (e.g., pipetting) system. As such, the dispensation of the reagent onto the substrate 300 at the discrete dispensation locations 330 and/or along the continuous dispensation line 340 may be facilitated by the relative movement of the dispense nozzle with respect to the substrate 300 by the X-Y stage only, by the Y-Z stage only, or by a combination of the X-Y stage and the Y-Z stage. In some embodiments, the X-Y stage may agitate the substrate 300 to distribute the reagent dispensed on the substrate.

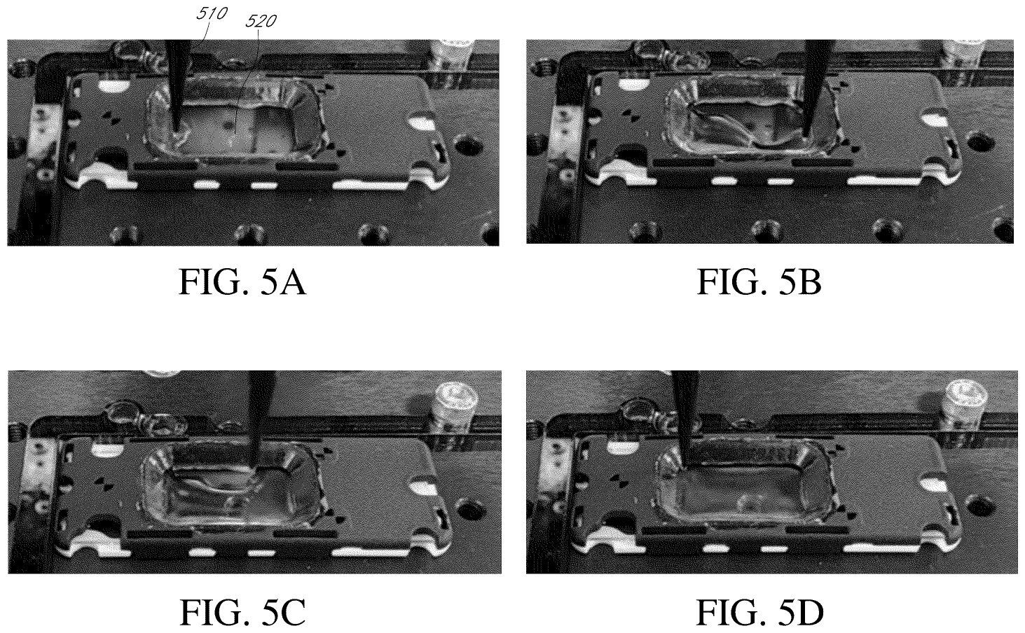

In some embodiments, the X-Y stage moves the sample device in one direction (e.g., X-direction or Y-direction) while the dispense nozzle is dispensing a reagent onto the substrate 300. Then, the X-Y stage may cease the movement, and the Y-Z stage moves the dispense nozzle in the Y-direction that is at an angle relative to the X-direction while the dispense nozzle is still dispensing the reagent. For example, the Y-Z stage moves the dispense nozzle in the Y-direction after the X-Y stage moves the substrate in the X-direction (e.g., and as such the angle is about 90°). That is, the sample device/substrate 300 and the dispense nozzle may move successively. In some embodiments, dispensation of the reagent at the discrete dispensation locations 330 and/or along the continuous dispensation line 340 may occur around the perimeter of the substrate 300. FIGS. 5A-5D show example illustrations of such dispensation pattern where a still dispense nozzle 510 starts dispensing reagent at one corner of a substrate 520 that may be rectangle-shaped (FIG. 5A) while the X-Y stage moves the sample device along the X-direction, i.e., in the negative x-direction (FIG. 5B). Then, the X-Y stage stops moving the sample device and the Y-Z stage moves the dispense nozzle along the positive Y-direction (FIG. 5C) while the dispense nozzle is still dispensing the reagent onto the substrate 520. Finally, the Y-Z stage stops moving the dispense nozzle and the X-Y stage moves the sample device back in the positive X-direction (FIG. 5D) while the dispense nozzle is dispensing the reagent. As such, the dispense nozzle traces the perimeter of the substrate 520 and dispenses the reagent onto the substrate 520 while doing so. In some embodiments, the X-Y stage and the Y-Z stage may be moving simultaneously while the dispense nozzle is dispensing. For example, the reagent may be dispensed onto the substrate 520 in an inward spiral pattern or an outward spiral pattern. In some embodiments, the reagent is dispensed at a variable rate. For example, in an inward or outward spiral pattern, the reagent is dispensed at a lower flow rate while over the sample region (so as to minimize forces on the sample) and a higher flow rate when outside of the sample region. In another example, reagent is dispensed at a first flow rate along one side of the sample well and a second flow rate along another side (e.g., a perpendicular side) of the sample well. In various embodiments, the first flow rate and the second flow rate are substantially the same. In various embodiments, the first flow rate is higher than the second flow rate. In various embodiments, the first flow rate is lower than the second flow rate.

In various embodiments, the amount of reagent that may be dispensed onto a substrate of a sample well may be an amount that is at least enough to fully immerse the sample that is positioned on the substrate. For example, the volume of the reagent may be given by the above expression

$$V = 2 A \sqrt{\frac{γ}{ρ g}} sin \frac{θ}{2} .$$

Further, the dispensation of this amount of the reagent may be configured to be completed before a pre-determined dispensation time period expires. In some embodiments, the dispensation of a reagent of volume V at the discrete dispensation locations 330 and/or along the continuous dispensation line 340 may occur within a preset time period, for example, before the pre-determined dispensation time for dispensing the reagent expires. For instance, the X-Y stage and/or the Y-Z stage may move at such a speed that allows the reagent is dispensed onto the substrate 300 before the pre-determined dispensation time period expires.

In various embodiments, the flow rate of the reagent when dispensed from the dispense nozzle onto the substrate may be selected such that the reagent is dripped on to the substrate (i.e., drip dispensing). In various embodiments, a flow rate for drip dispensing of the reagent allows droplets of reagent to form at an end of the dispensing nozzle and fall on to the substrate via gravity rather than forming a coherent stream of fluid out of the end of the dispensing nozzle.

In various embodiments, the flow rate of the reagent when dispensed from the dispense nozzle onto the substrate may be such that the reagent has a jetting flow. That is, the dispensed reagent may be streamed with jetting characteristics (e.g., instead of drips). In some embodiments, the dispensed reagent has a Weber number that corresponds to a jetting flow of the dispensed reagent. For example, the Weber number of the dispensed reagent may be in the range from about 3 to about 10, from about 4 to about 7.5, from about 4.5 to about 5.5, about 5, including values and subranges therebetween. In various embodiments, a pump that is operationally coupled to the dispense nozzle may pump the reagent at a flow rate that results in the noted Weber numbers for the dispensed reagent.

In various embodiments, once a dispensed reagent is used for probing a sample, or for treating a sample during imaging cycles (e.g., washing, stripping, probing, etc.), the used or spent reagent may then be extracted from the sample well. For example, an extraction nozzle may be positioned at a suitable height over the sample well at one or more reagent extraction locations, and the extraction nozzle may be used to extract the reagents at each of said one or more extraction locations. In various embodiments, the extraction nozzle can be the nozzle of a tube (e.g., sipper tube). In various embodiments, the extraction nozzle can be fluidically connected to a pumping mechanism (e.g., peristaltic pump, syringe pump, etc.) that draws reagents from the sample well into the extraction nozzle (e.g., and to a used reagent reservoir).

For instance, a pump that is operationally coupled to the extraction nozzle may be used to generate a pressure differential that extracts the reagent from the sample well. In some embodiments, the efficiency with which a used or spent reagent may be extracted from a sample well may depend at least in part on the hydrophilicity of the substrate of the sample well (i.e., on the contact angle the reagent makes with the surface of the substrate). That is, to achieve a desired extraction efficiency, the number of reagent extraction locations on a substrate may be increased or decreased based at least in part on the contact angle the reagent (e.g., a puddle of the reagent) makes with the surface of the substrate. For example, for probe reagents such as those including oligonucleotide probes, the number of extraction locations may exceed two when the contact angle is greater than about 50°, about 60°, about 65°, about 70°, etc.

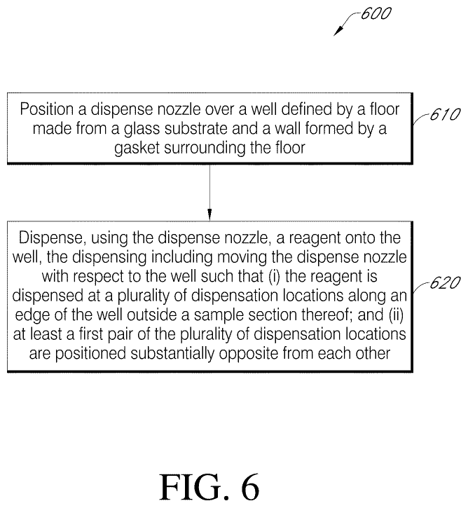

FIG. 6 is a flowchart illustrating a method 600 for dispensing reagents into a well of a sample device, according to various embodiments. Aspects of the method 600 can be executed by the fluidics module 140, the sample module 160, etc., of FIG. 1, and/or other suitable means for performing the steps. As illustrated, the method 600 includes a number of enumerated steps, but aspects of the method 600 may include additional steps before, after, and in between the enumerated steps. In some embodiments, one or more of the enumerated steps may be omitted or performed in a different order. In some embodiments, method 600 may begin with providing an optofluidic instrument comprising: an optics module, a fluidics module having a dispense nozzle, and a sample interface module.

At block 610, a dispense nozzle is positioned over a well. The well may be defined by a first portion of a substrate and a wall formed by a gasket surrounding the first portion. In some embodiments, the well may be defined by a floor made from a glass slide and a wall formed by a gasket surrounding the floor. For example, the dispense nozzle is positioned over a sample device having a well with a glass slide floor and a gasket wall.

At block 620, a reagent is dispensed onto the well. In some embodiments, the dispense nozzle may be moved with respect to the well in such a manner that (i) the reagent is dispensed at a plurality of dispensation locations along an edge of the well outside a sample section thereof; and (ii) at least a first pair of the plurality of dispensation locations are positioned substantially opposite from each other. In various embodiments, a stage onto which the sample device and/or the slide is disposed may be agitated after the dispensation of the reagent.

In various embodiments, the reagent is dispensed continuously along the edge of the well including at the plurality of dispensation locations. In some embodiments, the flow rate of the dispensed reagent may be such that the flow has a Weber number corresponding to jetting flow of the dispensed reagent. For example, the Weber number may range from about 3 to about 10, from about 4 to about 7, about 5, including values and subranges therebetween.

In various embodiments, the movement of the dispense nozzle with respect to the well may be successive in directions that are at an angle to each other while the reagent is being dispensed continuously. In various embodiments, the movement of the dispense nozzle with respect to the well may be simultaneous in directions that are at an angle to each other while the reagent is being dispensed continuously. In some embodiments, the angle can be about 90°. In various embodiments, the movement of the dispense nozzle with respect to the well may be such that the dispense nozzle dispenses the reagent at the plurality of dispensation locations before a pre-determined dispensation time expires.

In various embodiments, the dispense nozzle may be moved to at least a second pair of the plurality of dispensation locations. Further, the dispense nozzle may dispense the reagent at the at least the second pair of the plurality of dispensation locations. In some embodiments, the floor of the well has a generally rectangular shape and the at least the second pair of the plurality of dispensation locations include the four corners of the floor.

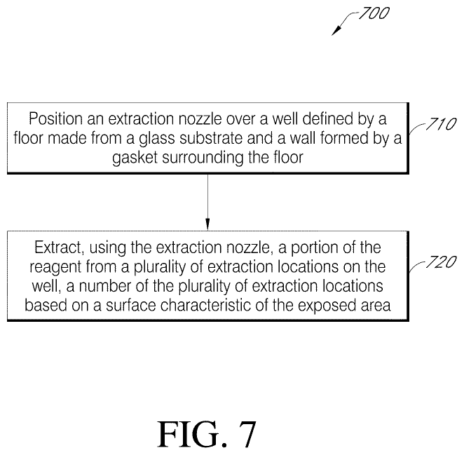

FIG. 7 is a flowchart illustrating a method 700 for extracting reagents from a well of a sample device, according to various embodiments. Aspects of the method 700 can be executed by the fluidics module 140, the sample module 160, etc., of FIG. 1, and/or other suitable means for performing the steps. As illustrated, the method 700 includes a number of enumerated steps, but aspects of the method 700 may include additional steps before, after, and in between the enumerated steps. In some embodiments, one or more of the enumerated steps may be omitted or performed in a different order.

At block 710, an extraction nozzle is positioned over a well, the well defined by a floor made from a glass slide and a wall formed by a gasket surrounding the floor. That is, the extraction nozzle is positioned over a sample device having a well with a glass slide floor and a gasket wall.

At block 720, the extraction nozzle is used to extract a portion of the reagent from a plurality of extraction locations on the well. In some embodiments, a number of the plurality of extraction locations may be based on a surface characteristic of the exposed area. In some embodiments, the surface characteristic comprises a hydrophilic coating of the glass slide. That is, for example, the number of the plurality of extraction locations may be based on the contact angle associated with the reagent and the slide. In some embodiments, the hydrophilic coating can be a hydrogel coating.

In various embodiments, the number of the plurality of extraction locations exceeds two when the contact angle is greater than about 50°, about 60°, about 70°, about 75°, etc. In various embodiments, at least a pair of the plurality of extraction locations are positioned substantially opposite from each other.

In various embodiments of method 600 or method 700, the reagent can be a washing buffer. For example, the washing buffer can be deionized water. As another example, the washing buffer can be phosphate-buffered saline (PBS). As another example, the washing buffer can be PBS with dimethyl sulfoxide (DMSO). In various embodiments, the reagent can be a stripping buffer. For example, the stripping buffer can be DMSO. As another example, the stripping buffer can be a surfactant. In some embodiments, the surfactant can be or include polysorbate 20. In some embodiments, the stripping buffer may include the surfactant in a weight proportion of about 0.1%.

In various embodiments, the reagent includes fluorescent probes. For example, the fluorescent probes can be oligonucleotide probes.

In various embodiments, the dispense nozzle can be a nozzle of a pipette. In various embodiments, the extraction nozzle can be a nozzle of a sipper tube.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

### V. Recitation of Embodiments

Embodiment 1: A method, comprising: providing an optofluidic instrument comprising: an optics module, a fluidics module having a dispense nozzle, and a sample interface module; positioning the dispense nozzle over a well, the well defined by a first portion of a substrate and a wall formed by a gasket surrounding the first portion; and dispensing, using the dispense nozzle, a reagent into the well, the dispensing including moving the dispense nozzle with respect to the well such that (i) the reagent is dispensed at a plurality of dispensation locations along an edge of the well and outside a sample section thereof; and (ii) at least a first pair of the plurality of dispensation locations are positioned substantially opposite from each other.

Embodiment 2: The method of claim 1, wherein the reagent is dispensed continuously along the edge of the well including at the plurality of dispensation locations.

Embodiment 3: The method of claim 1 or 2, further comprising adjusting a flow rate of the dispensed reagent so that flow of the dispensed reagent has a Weber number corresponding to jetting flow of the dispensed reagent.

Embodiment 4: The method of claim 3, wherein the Weber number ranges from about 3 to about 10.

Embodiment 5: The method of any of the preceding claims, further comprising: agitating, using a stage onto which the substrate is disposed, the substrate after the dispensation of the reagent.

Embodiment 6: The method of any of the preceding claims, wherein moving includes moving the dispense nozzle and the well successively in directions that are at an angle to each other while the reagent is being dispensed continuously.

Embodiment 7: The method of any of claims 1-5, wherein moving includes moving the dispense nozzle and the well simultaneously in directions that are at an angle to each other while the reagent is being dispensed continuously.

Embodiment 8: The method of claim 6 or 7, wherein the angle is about 90°.

Embodiment 9: The method of any of claims 1-5, wherein: moving includes moving the dispense nozzle to at least a second pair of the plurality of dispensation locations; and dispensing includes dispensing the reagent at the at least the second pair of the plurality of dispensation locations.

Embodiment 10: The method of claim 9, wherein the first portion has a rectangular shape and the at least the second pair of the plurality of dispensation locations include four corners of the first portion.

Embodiment 11: The method of any of the preceding claims, wherein moving includes moving the dispense nozzle with respect to the well such that the dispense nozzle dispenses the reagent at the plurality of dispensation locations before a pre-determined dispensation time expires.

Embodiment 12: The method of any of the preceding claims, wherein the reagent includes a washing buffer.

Embodiment 13: The method of claim 12, wherein the washing buffer includes deionized water, phosphate-buffered saline (PBS), or PBS with dimethyl sulfoxide (DMSO).

Embodiment 14: The method of any of the preceding claims, wherein the reagent includes a stripping buffer.

Embodiment 15: The method of claim 14, wherein the stripping buffer includes DMSO.

Embodiment 16: The method of claim 14 or 15, wherein the stripping buffer includes a surfactant.

Embodiment 17: The method of claim 16, wherein the surfactant includes polysorbate 20.

Embodiment 18: The method of any of claims 15-17, wherein the stripping buffer includes the surfactant in a weight proportion of about 0.1%.

Embodiment 19: The method of any of claims 1-11, wherein the reagent includes fluorescent probes.

Embodiment 20: The method of claim 19, wherein the fluorescent probes are oligonucleotide probes.

Embodiment 21: The method of any of claims 1-20, wherein the dispense nozzle is a nozzle of a pipette.

Embodiment 22: A method, comprising: providing an optofluidic instrument comprising: an optics module, a fluidics module having a dispense nozzle, and a sample interface module; positioning the extraction nozzle over a well, the well defined by a first portion of a substrate and a wall formed by a gasket surrounding the first portion; and extracting, using the extraction nozzle, at least a portion of the reagent from one or more extraction location in the well, wherein the one or more extraction location is selected based on a surface characteristic of the well.

Embodiment 23: The method of claim 22, wherein the surface characteristic comprises a hydrophilic coating of the substrate.

Embodiment 24: The method of claim 23, wherein the hydrophilic coating is a hydrogel coating.

Embodiment 25: The method of any of claims 22-24, wherein the one or more extraction location comprises two or more extraction locations when a contact angle is greater than 60 degrees.

Embodiment 26: The method of claim 25, wherein at least a pair of the two or more extraction locations are positioned substantially opposite from one another.

Embodiment 27: The method of any of claims 22-26, wherein the reagent includes a washing buffer.

Embodiment 28: The method of embodiment 27, wherein the washing buffer comprises deionized water, phosphate-buffered saline (PBS), or PBS with dimethyl sulfoxide (DMSO).

Embodiment 29: The method of any of embodiments 22-28, wherein the reagent includes a stripping buffer.

Embodiment 30: The method of embodiment 29, wherein the stripping buffer includes DMSO.

Embodiment 31: The method of embodiment 29 or 30, wherein the stripping buffer includes a surfactant.

Embodiment 32: The method of embodiment 31, wherein the surfactant includes polysorbate 20.

Embodiment 33: The method of any of embodiments 29-32, wherein the stripping buffer includes the surfactant in a weight proportion of about 0.1%.

Embodiment 34: The method of any of embodiments 22-26, wherein the reagent includes fluorescent probes.

Embodiment 35: The method of embodiment 34, wherein the fluorescent probes are oligonucleotide probes.

Embodiment 36: The method of any of embodiments 22-35, wherein the extraction nozzle is a nozzle of a sipper tube.

What is claimed is:

1. A method, comprising:
providing an optofluidic instrument comprising: an optics module, a fluidics module having a dispense nozzle, and a sample interface module;
positioning the dispense nozzle over a well, the well defined by a first portion of a substrate and a wall formed by a gasket surrounding the first portion; and
dispensing, using the dispense nozzle, a reagent into the well, the dispensing including moving the dispense nozzle with respect to the well such that (i) the reagent is dispensed at a plurality of dispensation locations along an edge of the well and outside a sample section thereof; and (ii) at least a first pair of the plurality of dispensation locations are positioned substantially opposite from each other.

2. The method of claim 1, wherein the reagent is dispensed continuously along the edge of the well including at the plurality of dispensation locations.

3. The method of claim 1, further comprising adjusting a flow rate of the dispensed reagent so that flow of the dispensed reagent has a Weber number corresponding to jetting flow of the dispensed reagent.

4. The method of claim 3, wherein the Weber number ranges from about 3 to about 10.

5. The method of claim 1, further comprising: agitating, using a stage onto which the substrate is disposed, the substrate after the dispensation of the reagent.

6. The method of claim 1, wherein moving includes moving the dispense nozzle and the well successively in directions that are at an angle to each other while the reagent is being dispensed continuously.

7. The method of claim 1, wherein moving includes moving the dispense nozzle and the well simultaneously in directions that are at an angle to each other while the reagent is being dispensed continuously.

8. The method of claim 6, wherein the angle is about 90°.

9. The method of claim 1, wherein:
moving includes moving the dispense nozzle to at least a second pair of the plurality of dispensation locations; and
dispensing includes dispensing the reagent at the at least the second pair of the plurality of dispensation locations.

10. The method of claim 9, wherein the first portion has a rectangular shape and the at least the second pair of the plurality of dispensation locations include four corners of the first portion.

11. The method of claim 1, wherein moving includes moving the dispense nozzle with respect to the well such that the dispense nozzle dispenses the reagent at the plurality of dispensation locations before a pre-determined dispensation time expires.

12. The method of claim 1, wherein the reagent includes at least one of a washing buffer or a stripping buffer.

13. The method of claim 12, wherein the washing buffer includes deionized water, phosphate-buffered saline (PBS), or PBS with dimethyl sulfoxide (DMSO).

14. The method of claim 12, wherein the stripping buffer includes at least one of a DMSO or a surfactant.

15. The method of claim 1, wherein the reagent includes fluorescent probes.

16. A method, comprising:
providing an optofluidic instrument comprising: an optics module, a fluidics module having a dispense nozzle, and a sample interface module;
positioning the extraction nozzle over a well, the well defined by a first portion of a substrate and a wall formed by a gasket surrounding the first portion; and
extracting, using the extraction nozzle, at least a portion of the reagent from one or more extraction location in the well, wherein the one or more extraction location is selected based on a surface characteristic of the well.

17. The method of claim 16, wherein the surface characteristic comprises a hydrophilic coating of the substrate.

18. The method of claim 17, wherein the hydrophilic coating is a hydrogel coating.

19. The method of claim 16, wherein the one or more extraction location comprises two or more extraction locations when a contact angle is greater than 60 degrees.

20. The method of claim 16, wherein at least a pair of the two or more extraction locations are positioned substantially opposite from one another.
